(19) United States
(12) Patent Application Publication
(10) Pub. No.: US 2005/0190757 A1
(43) Pub. Date: Sep. 1, 2005

(54) Interworking between Ethernet and non-Ethernet customer sites for VPLS

(75) Inventor: Ali Sajassi, Concord, CA (US)

Correspondence Address: BURGESS & BEREZNAK LLP, 800 WEST EL CAMINO REAL, SUITE 180, MOUNTAIN VIEW, CA, 94040, US

(73) Assignee: Cisco Technology Inc., San Jose, CA (US)

(21) Appl. No.: 10/789,141

(22) Filed: Feb. 27, 2004

(51) Int. Cl. H04L 12/56

(52) U.S. Cl. 370/389; 370/466

(57) ABSTRACT

A method and apparatus for interworking between customer edge (CE) devices connected to provider edge (PE) devices via attachment circuits (ACs), the PE devices routing packets across a service provider (SP) network, the CE devices including one or more Ethernet CE devices and a non-Ethernet CE. A virtual switch instance (VSI) is provided on a first PE device coupled to the non-Ethernet CE. The first PE device also including a virtual routing forwarding (VRF) entity interfaced with the VSI such that the SP network appears to offer L3VPN service toward the non-Ethernet CE and VPLS toward the one or more Ethernet CE devices. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### FIELD OF THE INVENTION

The present invention relates generally to digital computer network technology; more particularly, to methods and apparatus for providing metro Ethernet services.

### BACKGROUND OF THE INVENTION

Many enterprises are changing their business processes using advanced information technology (IT) applications to achieve enhanced productivity and operational efficiencies. These advanced applications tend to place increasing importance on peer-to-peer data communications, as compared to traditional client-server data communications. As a result, the underlying network architecture to support these applications is evolving to better accommodate this new model.

The performance of many peer-to-peer applications benefit from being implemented over service provider networks that support multipoint network services. A multipoint network service is one that allows each customer edge (CE) end point or node to communicate directly and independently with all other CE nodes via a single interface (either virtual or physical). Ethernet switched campus networks are an example of a multipoint service architecture. The multipoint network service contrasts with the hub-and-spoke network service, where the end customer designates one CE node to the hub that multiplexes multiple point-to-point services over a single User-Network Interface (UNI) to reach multiple “spoke” CE nodes. In a hub-and-spoke network architecture, each spoke can reach any other spoke only by communicating through the hub. Traditional wide area networks (WANs) such as Frame Relay (FR) and asynchronous transfer mode (ATM) networks are based on a hub-and-spoke service architecture.

Virtual Private Network (VPN) services provide secure network connections between different locations. A company, for example, can use a VPN to provide secure connections between geographically dispersed sites that need to access the corporate network. There are three types of VPN that are classified by the network layer used to establish the connection between the customer and provider network. Layer 1 VPNs are simple point-to-point connections such as leased lines, ISDN links, and dial-up connections. In a Layer 2 VPN (L2VPN) the provider delivers Layer 2 circuits to the customer (one for each site) and provides switching of the customer data. Customers map their Layer 3 routing to the circuit mesh, with customer routes being transparent to the provider. Many traditional L2VPNs are based on Frame Relay or ATM packet technologies. In a Layer 3 VPN (L3VPN) the provider router participates in the customer's Layer 3 routing. That is, the CE routers peer only with attached PEs, advertise their routes to the provider, and the provider router manages the VPN-specific routing tables, as well as distributing routes to remote sites. In a Layer 3 IP VPN, customer sites are connected via IP routers (PEs and P nodes) that can communicate privately over a shared backbone as if they are using their own private network. Multi-protocol label switching (MPLS) Border Gateway Protocol (BGP) networks are one type of L3VPN solution. An example of an IP-based Virtual Private Network is disclosed in U.S. Pat. No. 6,693,878. U.S. Pat. No. 6,665,273 describes a MPLS system within a network device for traffic engineering.

Virtual Private LAN Service (VPLS) has recently emerged to meet the need to connect geographically dispersed locations with a protocol-transparent, any-to-any, full-mesh service. VPLS is an architecture that delivers Layer 2 service that in all respects emulates an Ethernet LAN across a wide area network (WAN) and inherits the scaling characteristics of a LAN. All services in a VPLS appear to be on the same LAN, regardless of location. In other words, with VPLS, customers can communicate as if they were connected via a private Ethernet segment. Basically, VPLS offers a MPLS Layer 2 approach with multipoint connectivity, i.e., multipoint Ethernet LAN services, often referred to as Transparent LAN Service (TLS). VPLS thus supports the connection of multiple sites in a single bridged domain over a managed IP/MPLS network.

FIG. 1 illustrates an example of a VPLS architecture with an IP or MPLS core. All services are identified by a unique virtual channel label, which is exchanged between each pair of edge routers. Each PE-CE pair is shown connected by an Attachment Circuit (AC). An AC is the customer connection to a service provider network; that is, the connection between a CE and its associated PE. An AC may be a physical interface, or a virtual circuit, and may be any transport technology, i.e., Frame Relay, ATM, Ethernet VLAN, etc. In the context of a VPLS, an AC is typically an Ethernet interface. In the example of FIG. 1, each PE includes a Virtual Switch Instance (VSI) that provides an Ethernet bridge (i.e., switch) function that equates to a multi-point L2VPN. A Pseudo-Wire (PW) is shown connecting every two VSIs. A PW is a virtual connection that is bi-directional in nature and, in this example, consists of a pair of unidirectional MPLS Virtual Circuits (VCs). Conceptually, VPLS can therefore be thought of as an emulated Ethernet LAN network with each VSI being analogous to a virtual Ethernet switch.

Virtual channel labels are used by the edge routers to de-multiplex traffic arriving from different VPLS nodes. As traffic arrives on access ports, edge routers learn customer's Media Access Control (MAC) addresses. Each router enters these learned addresses in a forwarding information base, or table of MAC addresses, it maintains for each VPN instance. Customer traffic is switched according to MAC addresses and forwarded across the service provider network using appropriate PWs.

There are certain scenarios where a service provider wishes to provide VPLS service to a customer who has sites with disparate Attachment Circuit (AC) types (heterogeneous transport). For instance, a customer may have some sites with ATM ACs, some sites with FR ACs, and still other sites with Ethernet ACs. In situations where the ACs are all of the same technology, i.e., homogeneous, no transport problem exists. However, when a customer site does not use the same homogeneous interface as the other CEs, some sort of interworking function is needed.

One solution to the problem of providing VPLS to a customer with sites having different AC types is to mandate that the Native Service (NS) be of type Ethernet end-to-end (e.g., among the CE devices). Native Service refers to the common end-to-end service that is carried over the ACs between the two CEs. For example, an AC between a CE and a PE can be ATM or FR, but the NS can be Ethernet (e.g., Ethernet over ATM or Ethernet over FR) As a practical matter, mandating the NS to be Ethernet end-to-end would mean that customers with ATM or FR CEs would have to reconfigure their associated ACs as a bridged interface or as a routed interface with Ethernet encapsulation. The difficulty with this approach is that many service providers are reluctant to adopt such configurations because their customer's CE devices either do not have such capability, or cannot easily be configured for such operation.

Another prior art approach for providing interworking between some non-Ethernet sites (e.g., sites with ATM, FR, etc.) and some Ethernet sites is to use L3VPN technology, such as RFC2547bis, and for the service providers to participate in the customer's routing by every PE device connected to its customer's CE devices. The drawback of this solution, however, is that it fails to address the desire of those service providers who wish to maintain the service offering to their customers at Layer 2; that is, service providers who want to offer VPLS service to their customers. This solution is also unacceptable to those customers who want to retain the ability to manage their data packet routes. In other words, although MPLS Layer 3 VPNs provide “any-to-any” connectivity, some enterprises are reluctant to relinquish routing control of their network and desire L2VPN services with multipoint connectivity.

Thus, there is a need for alternative methods and apparatus that would allow a service provider to offer L2VPN service such as VPLS to customers having CE devices with disparate interfaces without requiring any configuration changes to a customer's CE devices.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is an example of a typical prior art VPLS system.

FIG. 2 illustrates an exemplary VPLS system with interworking between a customer's Ethernet and non-Ethernet sites in accordance with one embodiment of the present invention.

FIG. 3 is an expanded view of a portion of the VPLS system shown in FIG. 2.

FIG. 4 illustrates a set of Virtual Routing Forwarding tables each of which is associated with a customer site in accordance with one embodiment of the present invention.

FIG. 5 is an expanded view of a portion of a VPLS system according to an alternative embodiment of the present invention.

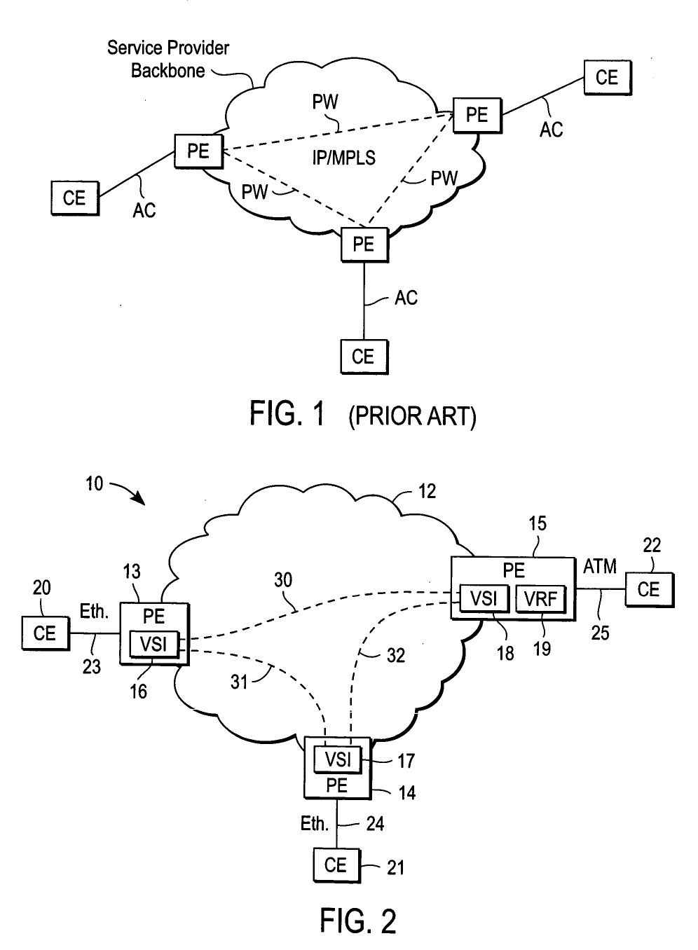

### DETAILED DESCRIPTION

A method and apparatus for providing VPLS service with interworking among a customer's heterogeneous sites (i.e., sites with Ethernet and non-Ethernet interfaces) without the need for configuration changes in the customer's CEs is described. In the following description specific details are set forth, such as device types, protocols, configurations, etc., in order to provide a thorough understanding of the present invention. However, persons having ordinary skill in the networking arts will appreciate that these specific details may not be needed to practice the present invention.

FIG. 2 illustrates an exemplary system 10 providing VPLS service to a customer having three sites/CEs in accordance with one embodiment of the present invention. A Service Provider (SP) network infrastructure 12 includes three Provider Edge devices 13-15, which are shown coupled to three customer sites/CEs 20-22 via ACs 23-25, respectively. CE 20 and 21 each have Ethernet interfaces, whereas Site-3/CE 22 is connected via ATM with routed interface. In other words, when CE 22 sends data packets to a destination device it transmits across an ATM AC. With routed encapsulation, an IP packet is encapsulated in the ATM frame, but no Ethernet bridge header is included.

Each PE in FIG. 2 includes an associated VSI, which functions like a logical Ethernet switch or bridge. That is, PE 13 has an associated VSI 16, PE 14 has an associated VSI 17, and PE 15 has an associated VSI 18. In the latter case, VSI 18 does not connect directly to CE 22 because AC 25 is of an ATM type with routed encapsulation. However, VSI expects to see an Ethernet header attached to data packets it receives from CE 22. According to the present invention, a Virtual Routing Forwarding (VRF) entity 19 within PE 15 is utilized to provide interworking between the disparate type of AC (i.e., ATM) associated with CE 22 and the Ethernet interfaces of CEs 20 and 21. Whereas FIG. 2 illustrates an ATM AC connecting CE 22 with PE 15, it is appreciated that the present invention may be utilized to provide interworking between sites associated with a variety of disparate AC types (e.g., ATM, FR, etc.)

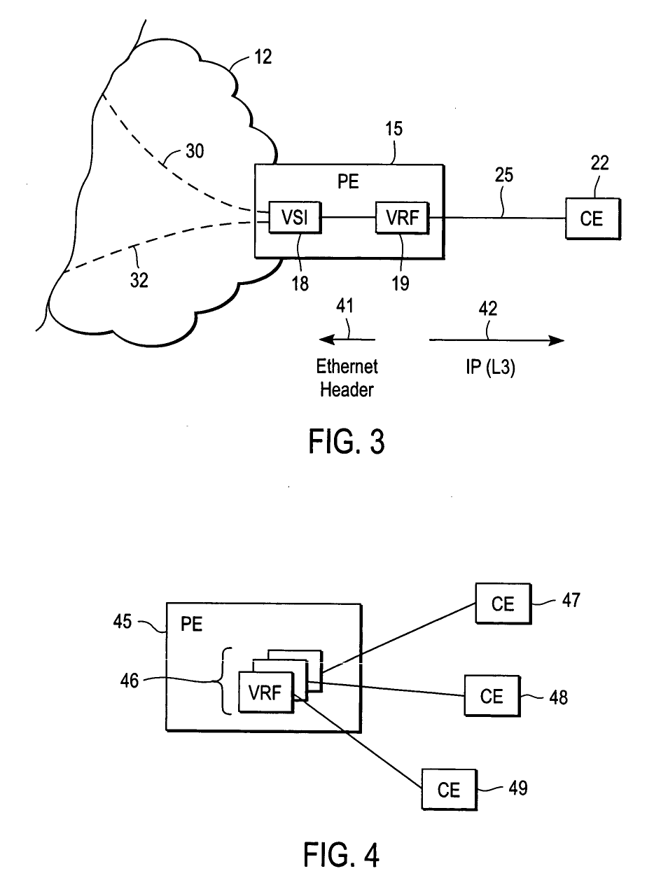

As can be seen in the expanded view of FIG. 3, VRF 19 is connected between CE 22 and VSI 18. The SP in system 10 thus provides VPLS service to CE 20 and CE 21, and L3VPN service to CE 22. Configured in this manner, VRF 19 of PE 15 can be viewed as a virtual router peering with CE 22 at one end, and with CEs 20 and 21 at the other end. Incoming data packets are delivered to CE 22 by VRF 19 with Layer 3 Internet protocol, as indicated by arrow 42 (see FIG. 3). In the other direction, VRF 19 is utilized to generate an Ethernet header for data packets transported from CE 22 to another end device via the SP network infrastructure. To achieve this result, VRF 19 strips the ATM header off the data packet, leaving the encapsulated IP header. VRF 19 then adds an Ethernet header to the packet so that it may be properly transported across the appropriate PW (e.g., either PW 30 or PW 32 in this example) via VSI 18. This latter operation is depicted in FIG. 3 by arrow 41.

Practitioners in the networking arts will appreciate that the plurality of VSIs 16-18 and PWs 30-32 connecting the VSIs together can be viewed as collectively comprising a logical LAN segment between VRF 19, CE 20 and CE 21. Since VRF 19 is peering with CEs 20-22, it is also involved in the Address Resolution Protocol (ARP) and the required routing protocol with these CEs. Just as each of the VSIs discovers or learns through ARP or other message exchanges among CEs which PW is associated with a particular Ethernet MAC address, VRF 19 also learns through ARP the Ethernet MAC address associated with a particular IP address.

Autodiscovery and signaling are well-known logical components of a VPLS system that allows PE devices to automatically discover other PE devices that have an association with a particular VPLS instance, and to set up and bind a PW to a particular VSI. Once the PEs have discovered other PEs that have an association with a particular VPLS instance, the PEs can then signal connections to interconnect the PEs associated with a particular VPLS instance. Practitioners will appreciate that there are many mechanisms that can be used to distribute VPLS associations between PE devices.

The tables of VSI 18 and VRF 19 self learn MAC address to port associations. For example, VSI 18 learns MAC addresses as the result of message exchanges between VRF 19 and CEs 20-21; whereas VRF 19 learns MAC addresses associated with CEs 20-22 as the result of ARP. The VSI will also associate the received frame's source MAC address with the ingress PW within its forwarding table for future forwarding decisions. In this way, when CE 22 sends data packets with routed encapsulation to another end point CE, VRF 19 looks up the Ethernet MAC address associated with the IP address of the packet and includes that address in the Ethernet header it generates, making it compatible with the connected VSI at Layer 2. (It should be kept in mind that VRF 19 is already peering with CE 22 at Layer 3.)

Thus, in the described example, VRF 19 stores the destination MAC addresses for each of the customer's sites/CEs (e.g., CE 20 and CE 21), so that it may formulate the data packet with the correct Ethernet header.

According to the interworking scheme of the present invention, it appears as if the SP is offering the L3VPN service toward the customer's CEs with routed interfaces, and offering the VPLS service toward the customer's CEs with Ethernet interfaces. The interworking between the L3VPN and the VPLS services is achieved by having a VSI included on both the PEs providing VPLS functionality and on the PEs providing L3VPN functionality. The VSI interfaces with the L3VPN forwarding entity, e.g., VRF as defined in RFC2547. In other words, if a customer has one or more non-Ethernet sites, then the VRFs associated with these non-Ethernet sites can be considered as connected to each other through a LAN segment, which is emulated by the VPLS service instance for that customer.

As a further example, consider a case in which a customer has ten sites, two of which have non-Ethernet connections. The remaining eight have Ethernet connections to their corresponding PE devices. The PE devices that are connected to the non-Ethernet sites may be configured as shown in FIG. 3 to support both VSI and VRF entities; whereas the PE devices connected to the Ethernet sites only need to support VSIs. The VRF provides IP VPN service (Layer 3) toward the non-Ethernet CE devices, and is configured to add an Ethernet header with the appropriate MAC address to packets sent by the non-Ethernet CE to another site via the VSI connected to the VRF. The VPLS service instance for that customer can be considered as providing an emulated bridged LAN segment among the eight customer's CEs with Ethernet connections and the corresponding VRFs connecting to the two customer's non-Ethernet CEs.

The present invention also provides an aggregation mechanism for IP VPN (L3VPN). The end-to-end network can be considered as a two-tiered network: The first, aggregation tier consists of VPLS with PE devices that emulate an Ethernet bridged LAN at Layer 2. The second, core-network tier comprises L3VPN PE devices. Persons of skill in the networking arts will appreciate that this aggregation mechanism is efficient; that is, many CEs may be aggregated in to a single interface of a L3VPN PE. Instead of using a single interface for each CE, a single VLAN interface can be utilized to provide connectivity to all CEs belonging to the same VPN in a given access network.

Although PE 15 of FIGS. 2 & 3 is shown with a single VRF entity, it should be understood that provider edge devices in a Layer 3 VPN may comprise multiple VRF tables. By way of example, FIG. 4 is a magnified view of a L3VPN PE device 45 that shows a set of VRF tables 46 connected to CEs 47-49. In this example, each VRF table is connected to a CE of a different customer. Similarly, multiple VSIs may be present in a single PE, with each VSI being connected to a different customer.

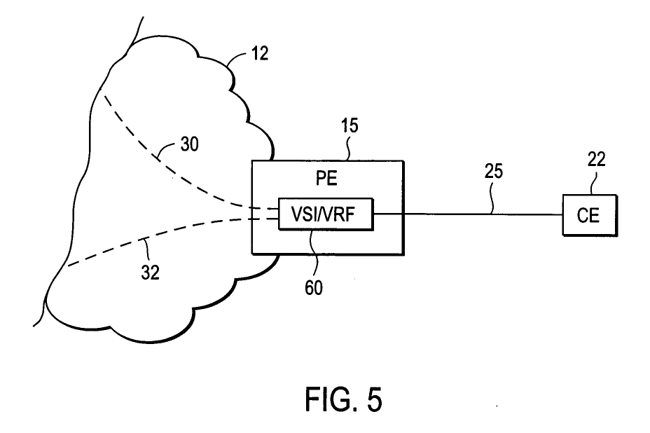

It should also be understood that although the embodiments described thus far have shown the VSI and VRF entities as separate forwarding tables (one for Layer 2 and the other for Layer 3), other implementations may combine the two tables into one single forwarding table function. For example, FIG. 5 illustrates a portion of a VPLS system according to an alternative embodiment of the present invention in which the separate VSI and VRF entities are combined into a single integrated forwarding table 60 within PE 15. Forwarding table 60 is shown connected to CE 22 via AC 25, and to PWs 30 & 32.

Persons of skill in the art will appreciate that VSIs 16-18 and VRF 19 can be implemented in a variety of ways. For example, any of these entities may be implemented in software, hardware, or firmware that either resides within the PE device, or is accessible by the PE through various media.

It should also be understood that elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Additionally, although the present invention has been described in conjunction with specific embodiments, numerous modifications and alterations are well within the scope of the present invention. Accordingly, the specification and drawings are to be regarded in an illustrative rather than a restrictive sense.

1. A method of interworking between a plurality of customer edge (CE) devices correspondingly coupled to provider edge (PE) devices via attachment circuits (ACs), the PE devices for routing packets across a service provider (SP) network, the CE devices including one or more Ethernet CE devices and at least one non-Ethernet CE, the method comprising:
providing a virtual switch instance (VSI) on a first PE device coupled to the at least one non-Ethernet CE, the first PE device also including a virtual routing forwarding (VRF) entity;
interfacing the VSI with the VRF entity such that the SP network appears to offer Layer 3 virtual private network (L3VPN) service toward the at least one non-Ethernet CE, and virtual private local area network service (VPLS) toward the one or more Ethernet CE devices.

2. The method of claim 1 wherein the VSI and VRF entity comprise a single integrated entity.

3. The method of claim 1 wherein the VSI and VRF entity comprise separate forwarding tables.

4. The method of claim 1 wherein the VSI comprises forwarding tables for population with media access control (MAC) addresses of the CE devices.

5. A method of providing virtual private network (VPN) service to a customer having a plurality of sites, one or more of the sites having Ethernet interfaces and at least one site having a non-Ethernet routed interface, each of the sites being connected across a service provider (SP) network via a corresponding provider edge (PE) device, the method comprising:
providing a logical entity on a PE device connected to the at least one site, the logical entity:
adding an Ethernet header to a Layer 3 packet for transport across the SP network to a destination site; and
delivering a packet at Layer 3 to the site having the non-Ethernet routed interface.

6. The method of claim 5 wherein the site is connected to the PE device via an asynchronous transfer mode (ATM) type of attachment circuit (AC).

7. The method of claim 5 wherein the site is connected to the PE device via a frame relay (FR) type of attachment circuit (AC).

8. The method of claim 5 wherein the logical entity comprises separate virtual switch instance (VSI) and virtual routing forwarding (VRF) tables.

9. The method of claim 5 wherein the logical entity comprises a single combined virtual switch instance (VSI)/virtual routing forwarding (VRF) table.

10. A multi-tiered virtual private network (VPN) comprising:
a first tier that includes a plurality of provider edge (PE) devices providing virtual private local area network service (VPLS) functionality to customer edge (CE) devices having Ethernet interfaces; and
a second tier that includes one or more PE devices providing Layer 3 virtual private network (L3VPN) functionality, the one or more PE devices including a virtual routing forwarding (VRF) entity, and a virtual switch instance (VSI) interfaced that emulates a bridged local area network (LAN) segment.

11. The multi-tiered VPN of claim 10 wherein the VSI and VRF entity comprise a single combined entity.

12. The multi-tiered VPN of claim 10 further comprising a service provider (SP) network providing connectivity between the first tier PE devices.

13. The multi-tiered VPN of claim 10 wherein the VSI and VRF entity comprise separate forwarding tables.

14. The method of claim 10 wherein the VSI and VRF entity comprise forwarding tables for population with media access control (MAC) addresses of the CE devices.

15. A provider edge (PE) device for connection to a service provider (SP) network and a customer edge (CE) device having a non-Ethernet interface comprising:
a virtual switch instance (VSI);
a virtual routing forwarding (VRF) entity configured with the VSI such that the SP network effectively offers Layer 3 virtual private network (L3VPN) service toward the at least one non-Ethernet CE, and virtual private local area network service (VPLS) toward the one or more Ethernet CE devices.

16. The PE device of claim 15 wherein the VSI and VRF entity comprise a single combined entity.

17. The PE device of claim 15 wherein the VSI and VRF entity comprise separate forwarding tables.

18. The PE device of claim 10 wherein the VRF entity comprises a plurality of forwarding tables.

19. A provider edge (PE) device for association with a customer edge (CE) device having a non-Ethernet routed interface, comprising:
a virtual switch instance (VSI) for connection to a service provider (SP) network, the VSI providing an Ethernet-compatible interface to the SP network;
a virtual routing forwarding (VRF) entity configured with the VSI to deliver Layer 3 virtual private network (L3VPN) compatible packets toward the CE, the VFR adding an Ethernet header to packets sent by the CE for transport across the SP to a destination customer site.

20. The PE device of claim 19 wherein the VSI and VRF entity comprise a single combined entity.

21. The PE device of claim 19 wherein the VSI and VRF entity comprise separate forwarding tables.

22. The PE device of claim 19 wherein the VRF entity comprises a plurality of forwarding tables.

23. A provider edge (PE) device for association with a customer edge (CE) device having a non-Ethernet routed interface, comprising:
means for providing an Ethernet-compatible interface for connection to a service provider (SP) network;
means for delivering Layer 3 virtual private network (L3VPN) compatible packets to the CE, and for adding an Ethernet header to packets sent by the CE for transport across the SP to a destination customer site.

24. The PE device of claim 23 wherein the means for providing an Ethernet-compatible interface comprises a virtual switch instance (VSI).

25. The PE device of claim 23 wherein the means for delivering Layer 3 virtual private network (L3VPN) compatible packets to the CE comprises a virtual routing forwarding (VRF) entity.

26. The PE device of claim 25 wherein the VRF entity comprises one or more forwarding tables.

27. A provider edge (PE) device for association with a customer edge (CE) device having a non-Ethernet routed interface, comprising:
means for providing an Ethernet-compatible interface for connection to a service provider (SP) network;
means for adding an Ethernet header to packets sent by the CE for transport across the SP to a destination customer site.

28. The PE device of claim 27 wherein the means for providing an Ethernet-compatible interface comprises a virtual switch instance (VSI).

29. The PE device of claim 28 wherein the means for adding an Ethernet header to packets sent by the CE comprises a virtual routing forwarding (VRF) entity.

30. The PE device of claim 25 wherein the VRF entity comprises one or more forwarding tables.

31. A computer program product comprising a computer useable medium and computer readable code embodied on the computer useable medium, execution of the computer readable code causing the computer program product to:
provide an Ethernet-compatible interface on a provider edge (PE) device connected to a service provider (SP) network and to a customer edge (CE) device having a non-Ethernet routed interface;
deliver Layer 3 virtual private network (L3VPN) compatible packets from across the SP network to the CE device; and
add an Ethernet header to packets sent by the CE device for transport across the SP network to a destination device.

32. The computer program product of claim 31 wherein execution of the code causes the PE device to provide virtual private local area network service (VPLS) functionality for the CE device.
